(19) United States
(12) Patent Application Publication
(10) Pub. No.: US 2023/0157344 A1
(43) Pub. Date: May 25, 2023

(54) VITALITY DIETARY SUPPLEMENT

(71) Applicant: SOCIETE DES PRODUITS NESTLE S.A., Vevey (CH)

(72) Inventors: KURT SEIDENSTICKER, Chicago, IL (US); KATIE COTE, Chicago, IL (US); CRISTINA CUTRI, Chicago, IL (US); COREY FRIESE, Chicago, IL (US); LUIS VARGAS, Chicago, IL (US)

(21) Appl. No.: 17/995,131

(22) PCT Filed: Apr. 1, 2021
(86) PCT No.: PCT/EP2021/058560

§ 371 Date: Sep. 30, 2022

Related U.S. Application Data
(60) Provisional application No. 63/005,725, filed on Apr. 6, 2020.

(51) Int. Cl. A23L 33/28; A23L 33/135; A23L 33/14; A23L 33/175; A23L 33/18

(52) U.S. Cl. CPC A23L 33/28; A23L 33/135; A23L 33/14; A23L 33/175; A23L 33/18

(57) ABSTRACT

The present invention is directed to improving immune function by improving or increasing the function of immune cells, promoting adequate hydration, and supplying essential nutrients and amino acids that the immune system requires to function. The supplement composition of the present invention comprises: Collagen Peptides, 1-glutamine, 1-arginine, Baker's Yeast Beta Glucan, 1-tryptophan, Heat-Killed Lactobacillus plantarum, vitamins, and minerals. Immune system function is improved using this combination of components.

### FIELD OF THE INVENTION

The present invention is directed to improving immune function by improving or increasing the function of immune cells, promoting adequate hydration, and supplying essential nutrients and amino acids that the immune system requires to function. The supplement composition of the present invention comprises: Collagen Peptides, 1-glutamine, 1-arginine, Baker's Yeast Beta Glucan, 1-tryptophan, Heat-Killed Lactobacillus plantarum, vitamins, and minerals. Immune system function is improved using this combination of components.

### BACKGROUND OF THE INVENTION

Every day, thousands of people succumb to the common cold, flu, or other contagious illnesses such as Coronavirus disease (COVID). Many people choose to supplement their diet with functional foods or dietary supplements in order to help bolster their immune system and put themselves in a better position to ward off these illnesses. The ingestion of capsules, tablets, nutritional beverages, or drink powder mixes has been a preferred method to help promote these immune-supporting functions, either by taking daily or immediately before and during the onset of symptoms.

While adequate nutrition, sleep, and practicing good hygiene such as washing hands or avoiding highly congested areas of human traffic are the front lines of defense in supporting the immune system and avoiding a contagious illness, certain ingestible dietary supplements and ingredients have the potential to enhance and improve the function of the immune system and provide the body the support it needs to fight off illness. These parameters can include improving or increasing the function of immune cells, promoting adequate hydration, and supplying essential nutrients and amino acids that the immune system requires to function.

Research has shown that several dietary supplement ingredients have inherit properties that support these immune functions including: Sodium, Potassium, Magnesium, Vitamin C, Vitamin D, Zinc, Collagen, 1-glutamine, 1-arginine, 1-tryptophan, Wellmune® Baker's Yeast Beta Glucan, Immuno-LP20R® (Heat-Killed Lactobacillus plantarum L-137).

There remains a need to improve immune function by providing essential vitamins and minerals, amino acids, and immune-enhancing specialty ingredients. The present invention resolves this deficiency and enhances the uptake of these ingredients and helps support immune function.

### SUMMARY OF THE INVENTION

The present invention is directed to a dietary supplement composition comprising collagen peptides, 1-glutamine, 1-arginine, Baker's Yeast Beta Glucan, 1-tryptophan, Heat-Killed Lactobacillus plantarum, vitamins, and minerals.

In one embodiment, the collagen peptides are present in an amount of about 7 to 69 weight percent of the composition, 1-glutamine is present in an amount of about 3 to about 31 weight percent of the composition, 1-arginine is present in an amount of about 0.7 to about 8 weight percent of the composition, Baker's Yeast Beta Glucan is present in an amount of about 0.3 to about 4 weight percent of the composition, 1-tryptophan is present in an amount of about 0.1 to about 0.8 weight percent of the composition, and Heat-Killed Lactobacillus plantarum L-137 is present in an amount of about 0.1 to about 0.8 weight percent of the composition.

The compositions of the present invention are intended to support and enhance immune system function.

### DETAILED DESCRIPTION OF THE INVENTION

The present invention relates to a dietary supplement composition that may be consumed as a supplement to support and enhance immune system function

The compositions of the present invention comprise collagen, preferably in the form of hydrolyzed collagen peptides, in combination with 1-glutamine, 1-arginine, Baker's Yeast Beta Glucan, 1-tryptophan, Heat-Killed Lactobacillus plantarum, optionally, additional vitamins and minerals.

The composition may be administered in the form of a liquid, solution, suspension, powder, or gel. If in powder form, the powder is mixed in a soluble liquid prior to administration as directed.

Collagen is present in the composition in an amount of about 7 to 69 weight percent of the composition, about 20 to 54 weight percent of the composition, or about 27 to 46 weight percent of the composition. Alternatively, collagen may be present in the composition in an amount of about 1-9 grams/serving, about 3-7 grams/serving, or about 4-6 grams/serving. In a preferred embodiment, collagen may be present in the composition in an amount of about 5 grams/serving. Collagen is a protein and may be present in any available form in the composition. However, the present invention preferably uses collagen peptides. Collagen peptides may be sourced from any known source, including but not limited to, beef, chicken, fish, eggshell membrane, and chicken egg whites.

L-glutamine is present in the composition in an amount of about 0.5-4.0 g/serving, about 1-3 g/serving, about 1.5-2.5 g/serving, or about 2 g/serving. Alternatively, 1-glutamine may be present in the composition in an amount of about 3-31 weight percent, about 7-23 weight percent, or about 10-19 weight percent.

L-arginine is also present in the composition in an amount of about 0.1-1 g/serving, about 0.25-0.75 g/serving, about 0.4-0.6 g/serving, or about 0.5 g/serving. Alternatively, 1-arginine may be present in the composition in an amount of about 0.7-8 weight percent, about 2-6 weight percent, or about 3-5 weight percent.

Baker's Yeast Beta Glucan is also present in the composition in an amount of about 0.05-0.5 g/serving, about 0.15-0.4 g/serving, about 0.2-0.3 g/serving, or about 0.25 g/serving. Alternatively, Baker's Yeast Beta Glucan may be present in the composition in an amount of about 0.3-4.0 weight percent, about 1-3.1 weight percent, or about 1.3-2 weight percent. In a preferred embodiment, Wellmune® Baker's Yeast Beta Glucan is used.

L-tryptophan is also present in the composition in an amount of about 0.01-0.1 g/serving, about 0.025-0.075 g/serving, about 0.04-0.06 g/serving, or about 0.05 g/serving. Alternatively, I-tryptophan may be present in the composition in an amount of about 0.1-0.8 weight percent, about 0.2-0.6 weight percent, or about 0.3-0.5 weight percent.

Heat-Killed Lactobacillus plantarum L-137 is also present in the composition in an amount of about 0.01-0.1 g/serving, about 0.025-0.075 g/serving, about 0.04-0.06 g/serving, or about 0.05 g/serving. Alternatively, Heat-Killed Lactobacillus plantarum L-137 may be present in the composition in an amount of about 0.1-0.8 weight percent, about 0.2-0.6 weight percent, or about 0.3-0.5 weight percent. In a preferred embodiment, Immuno-LP20® (Heat-Killed Lactobacillus plantarum L-137) is used.

Additional nutrients may be used in the composition including electrolytes, vitamins, minerals, and other dietary supplements. Suitable electrolyte minerals include, but are not limited to calcium, sodium, potassium, magnesium, calcium, bicarbonate, chloride, zinc and phosphate. The total amount of electrolyte minerals may be added to the composition in an amount of about 7-39 weight percent of the composition, about 10-23, or about 15-21 weight percent of the composition. Alternatively, the total electrolytes may be present in a range of about 1-5 grams/serving, about 1.5-3 grams/serving, or about 2.25-2.75 grams/serving.

Sodium may be present in any form, such as sea salt, iodized salt, sodium bicarbonate, or Himalayan pink sea salt, in an amount of about 0.2-1 grams/serving or 0.3-0.7 grams/serving, or about 1.3-8 weight percent or about 2-6 weight percent of the total composition.

Potassium may be present in any suitable form, such as a potassium citrate, potassium chloride, potassium sorbate, or the like. Potassium may be present in an amount of about 0.1-2 grams/serving or about 0.2-1 grams/serving, or about 0.7-15 or about 1.3-8 weight percent of the total composition.

Magnesium may be present in any suitable form, such as a magnesium citrate, magnesium oxide, magnesium lysinate-glycinate chelate, or magnesium malate. Magnesium may be present in an amount of about 0.01-0.2 grams/serving or about 0.02-0.1 grams/serving, or about 0.1-1.5 or about 0.1-0.8 weight percent of the total composition.

Zinc may be present in any suitable form, such as a zinc sulfate or zinc citrate. Zinc may be present in an amount of about 0.01-0.2 grams/serving or about 0.01-0.1 grams/serving, or about 0.1-1.5 or about 0.1-0.8 weight percent of the total composition.

Vitamins may further be added to the composition. Any vitamins suitable for ingestion in a dietary supplement is suitable for use. Suitable vitamins include but are not limited to Vitamin B, including Vitamin B1 (e.g., as thiamine chloride), Vitamin B2 (e.g., as riboflavin), Vitamin B3 (e.g., niacinamide), Vitamin B6 (e.g., as pyridoxine HCl), Vitamin B5 (e.g., as pantothenic acid or D-calcium pantothenate), Vitamin B12 (cyanocobalamin), folate (e.g., as folic acid), Vitamin C (e.g., as sodium ascorbate), Vitamin D, Vitamin E, etc. In the context of the present invention, each of the vitamins may be independently present in the composition in an amount of about 0.01-2 grams/serving, about 0.5-1.5 grams/serving, about 0.75-1.25 grams/serving, or about 0.001-15.4, about 3-12, or about 5-10 weight percent of the total composition.

Moreover, the composition may be flavored using any known natural flavors to enhance the flavor of the composition. Additionally, other additives suitable for dietary supplements, including but not limited to, monk fruit extract, Himalayan pink sea salt, fruit and vegetable juice powder, beta-carotene, citric acid, and malic acid

In accordance with the present invention, suitable compositions include, but are not limited, to those described in Table 1.

TABLE 1

| | | |
|---|---|---|
| Ingredient | Amount per serving | % Daily Value |

| | | | |
|---|---|---|---|
| Collagen peptides | 5 | g | ** |
| (from bovine) | | | |
| L-Glutamine | 2 | g | ** |
| L-Arginine | 500 | mg | ** |
| Wellmune baker's yeast | 250 | mg | ** |
| beta glucan | | | |
| (from Saccharomyces | | | |
| cerevisiae) | | | |
| L-Tryptophan | 50 | mg | ** |
| Immuno-LP20 | 50 | mg | ** |
| (heat-killed | | | |
| Lactobacillus | | | |
| plantarum strain L-137) | | | |
| Vitamin C | 1000 | mg | 1,111% |
| Vitamin D | 20 | mcg | 100% |
| (as cholecalciferol) | | | |
| Niacin | 8 | mg | 100% |
| (as niacinamide) | | | |
| Vitamin B6 | 1.7 | mg | 100% |
| (as pyridoxine HCl) | | | |
| Vitamin B12 | 4.8 | mcg | 200% |
| (as cyanocobalamin) | | | |
| Magnesium | 50 | mg | 12% |
| (as magnesium citrate) | | | |
| Zinc | 22 | mg | 200% |
| (as zinc citrate) | | | |
| Sodium | 500 | mg | 22% |
| Potassium | 400 | mg | 9% |
| (as potassium citrate) | | | |

| | | |
|---|---|---|
| Ingredient | Amount per serving | % Daily Value |

**Daily Value Not Established

In an embodiment of the present invention, the caloric intake of the supplement is less than about 100 calories, less than about 75 calories, or about 30 calories per serving. Additionally, the amount of carbohydrates and total sugars in the composition is desirably low. For example, the carbohydrates may be present in an amount of less than 10 grams/serving, less than 7 grams/serving, less than 5 grams/serving, about 2 grams/serving, or about 1 grams/serving. Similarly, the total sugars is desirably kept low, e.g., less than 6 grams/serving, less than 5 grams/serving, or about 0 gram/serving. As noted above, the content of the protein, in the form of collagen or collagen peptides, is high, preferably above 2 grams/serving, above 4 gram/serving, or about 5 grams/serving.

### Example 1

A composition of the formula depicted in Table 1 was prepared.

1. A dietary supplement composition comprising collagen in an amount of about 7 to 69 weight percent of the composition, 1-glutamine in an amount of about 3 to 31 weight percent of the combination, 1-arginine in an amount of about 0.7 to 8 weight percent of the composition, Baker's Yeast Beta Glucan in an amount of about 0.3 to 4.0 weight percent of the composition, 1-tryptophan in an amount of about 0.1 to 0.8 weight percent of the composition, and Heat-Killed Lactobacillus plantarum L-137 in an amount of about 0.1 to 0.8 weight percent of the composition.

2. The dietary supplement composition of claim 1, wherein the collagen is present in the form of hydrolyzed collagen peptides.

3. The dietary supplement composition of claim 1, wherein the composition further comprises electrolyte minerals and wherein total amount of electrolyte minerals is present in an amount of about 7 to 39 weight percent of the total composition.

4. The dietary supplement composition of claim 1, wherein the composition further comprises vitamins suitable for ingestion in a dietary supplement and wherein each such vitamin is present in an amount of about 0.001-15.4 weight percent of the total composition.

5. The dietary supplement composition according to claim 1, wherein the composition is a powder.

6. The dietary supplement composition according to claim 1, wherein the composition is a liquid.

7. The dietary supplement composition of claim 1, wherein collagen is present in an amount of about 20 to 54 weight percent of the composition, 1-glutamine in an amount of about 7 to 23 weight percent of the combination, 1-arginine in an amount of about 2 to 6 weight percent of the composition, Baker's Yeast Beta Glucan in an amount of about 1 to 3.1 weight percent of the composition, 1-tryptophan in an amount of about 0.2 to 0.6 weight percent of the composition, and Heat-Killed Lactobacillus plantarum L-137 in an amount of about 0.2 to 0.6 weight percent of the composition.

8. The dietary supplement composition of claim 7, wherein the collagen is present in the form of hydrolyzed collagen peptides.

9. The dietary supplement composition of claim 7, wherein the composition further comprises electrolyte minerals and wherein total amount of electrolyte minerals is present in an amount of about 10 to 23 weight percent of the total composition.

10. The dietary supplement composition of claim 7, wherein the composition further comprises vitamins suitable for ingestion in a dietary supplement and wherein each such vitamin is present in an amount of about 3-12 weight percent of the total composition.

11. The dietary supplement composition of claim 7, wherein the composition is a powder.

12. The dietary supplement composition of claim 7, wherein the composition is a liquid.

13. The dietary supplement composition of claim 1, wherein collagen is present in an amount of about 27 to 46 weight percent of the composition, 1-glutamine in an amount of about 10 to 19 weight percent of the combination, 1-arginine in an amount of about 3 to 5 weight percent of the composition, Baker's Yeast Beta Glucan in an amount of about 1.3 to 2 weight percent of the composition, 1-tryptophan in an amount of about 0.3 to 0.5 weight percent of the composition, and (Heat-Killed Lactobacillus plantarum L-137) in an amount of about 0.3 to 0.5 weight percent of the composition.

14. The dietary supplement composition of claim 13, wherein the collagen is present in the form of hydrolyzed collagen peptides.

15. The dietary supplement composition of claim 13, wherein the composition further comprises electrolyte minerals and wherein total amount of electrolyte minerals is present in an amount of about 15 to 21 weight percent of the total composition.

16. The dietary supplement composition of claim 13, wherein the composition further comprises vitamins suitable for ingestion in a dietary supplement and wherein each such vitamin is present in an amount of about 5-10 weight percent of the total composition.

17. The dietary supplement composition of claim 13, wherein the composition is a powder.

18. The dietary supplement composition of claim 13, wherein the composition is a liquid.

19. A dietary supplement composition comprising the following ingredients:

| | | |
|---|---|---|
| Ingredient | Amount per serving | % Daily Value |
| | | | |
|---|---|---|---|
| Collagen peptides | 5 | g | ** |
| (from bovine) | | | |
| L-Glutamine | 2 | g | ** |
| L-Arginine | 500 | mg | ** |
| Wellmune baker's yeast | 250 | mg | ** |
| beta glucan | | | |
| (from Saccharomyces | | | |
| cerevisiae) | | | |
| L-Tryptophan | 50 | mg | ** |
| Immuno-LP20 | 50 | mg | ** |
| (heat-killed | | | |
| Lactobacillus | | | |
| plantarum strain L-137) | | | |
| Vitamin C | 1000 | mg | 1,111% |
| Vitamin D | 20 | mcg | 100% |
| (as cholecalciferol) | | | |
| Niacin | 8 | mg | 100% |
| (as niacinamide) | | | |
| Vitamin B6 | 1.7 | mg | 100% |
| (as pyridoxine HCl) | | | |
| Vitamin B12 | 4.8 | mcg | 200% |
| (as cyanocobalamin) | | | |
| Magnesium | 50 | mg | 12% |
| (as magnesium citrate) | | | |
| Zinc | 22 | mg | 200% |
| (as zinc citrate) | | | |
| Sodium | 500 | mg | 22% |
| Potassium | 400 | mg | 9% |
| (as potassium citrate) | | | |

**Daily Value Not Established

20. A method of improving immune system function comprising administering to a patient in need thereof a composition comprising collagen in an amount of about 7 to 69 weight percent of the composition, 1-glutamine in an amount of about 3 to 31 weight percent of the combination, 1-arginine in an amount of about 0.7 to 8 weight percent of the composition, Baker's Yeast Beta Glucan in an amount of about 0.3 to 4.0 weight percent of the composition, 1-tryptophan in an amount of about 0.1 to 0.8 weight percent of the composition, and Heat-Killed Lactobacillus plantarum L-137 in an amount of about 0.1 to 0.8 weight percent of the composition.
